(19) United States
(12) Patent Application Publication
(10) Pub. No.: US 2014/0344428 A1
(43) Pub. Date: Nov. 20, 2014

(54) SYSTEM ARCHITECTURE SUPPORT TOOL

(71) Applicants: Tomofumi Ishihara, Chiyoda-ku (JP); Nobuyuki Ban, Chiyoda-ku (JP); Takayuki Amano, Chiyoda-ku (JP); Ryo Uchida, Chiyoda-ku (JP)

(72) Inventors: Tomofumi Ishihara, Chiyoda-ku (JP); Nobuyuki Ban, Chiyoda-ku (JP); Takayuki Amano, Chiyoda-ku (JP); Ryo Uchida, Chiyoda-ku (JP)

(73) Assignee: MITSUBISHI ELECTRIC CORPORATION, Chiyoda-ku, Tokyo (JP)

(21) Appl. No.: 14/370,242

(22) PCT Filed: Feb. 24, 2012
(86) PCT No.: PCT/JP2012/054656

§ 371 Date: Jul. 2, 2014

(51) Int. Cl. H04L 12/24; G06F 3/0484

(52) U.S. Cl. CPC H04L 41/0806; G06F 3/0484
USPC 709/222

(57) ABSTRACT

A display unit that displays a system-configuration setting screen including a system-configuration display area and a list display area; a collaboration-software product-specification storage unit that stores therein a setting target of collaboration software and network information in association with each other for each collaboration software, the network information indicating a network used for connection of the setting target; a collaboration-software display unit that list-displays collaboration software stored in the collaboration-software product-specification storage unit as a component list in the list display area; an automatic connection checking unit that determines whether the collaboration software selected from the component list and arranged in the system-configuration display area can be connected to the setting target based on the network information; and a collaboration-software arrangement unit that connects, an image representing the collaboration software to a system displayed in the system-configuration display area.

### FIELD

The present invention relates to a system architecture support tool that is used when a system including a programmable logic controller (PLC: Programmable Logic Controller), a display device (a programmable display device) and the like is constructed.

### BACKGROUND

A PLC is used as a control device of industrial machines and the like. The PLC is constituted by a base unit and a plurality of units arranged on the base unit.

That is, the PLC is constituted by appropriately combining various units such as: a power supply unit of a power supply source; a CPU (Central Processing Unit) unit that manages control of the entire PLC; a motion CPU unit that controls a servo motor via a servo amplifier mounted on a drive unit of a production apparatus or an installation apparatus; an input unit that inputs signals of switches and sensors mounted on appropriate positions of the production apparatus or the installation apparatus; an output unit that outputs a control output to an actuator or the like; and a communication unit that connects the PLC to a communication network.

In a control device of industrial machines and the like, a display device other than the PLC is also used. The display device displays an operation screen created by a user. Controlling and monitoring of a system are performed by connecting the display device to the PLC or other display devices and operating the control device from the created screen.

Conventionally, at the time of operating a control device such as a PLC and a display device, a user is required to consider how to construct the system, and the more complicated and larger the system is, the greater the burden on the user at the time of system construction is. A system architecture support tool is a tool for reducing the burden when the system is constructed.

Techniques related to such a system architecture support tool are disclosed in Patent Literatures 1, 2, and 3.

### CITATION LIST

### Patent Literatures

Patent Literature 1: Japanese Patent Application Laid-open No. 2002-222300

Patent Literature 2: Japanese Patent Application Laid-open No. 2003-288458

Patent Literature 3: Japanese Patent Application Laid-open No. 2008-033683

### SUMMARY

### Technical Problem

However, according to the techniques disclosed in Patent Literatures 1, 2, and 3 mentioned above, collaboration software (software used for setup of a unit) is set for system construction, for each component. Therefore, the setting needs to be repeated and the number of setting procedures is to be increased.

Furthermore, according to the techniques disclosed in Patent Literatures 1, 2, and 3 mentioned above, it is possible to display document components and components for setting a linkage to other files. However, the techniques do not display the collaboration software, thereby tools corresponding to the components need to be stored.

Further, according to the techniques disclosed in Patent Literatures 1, 2, and 3 mentioned above, a user is required to interactively check whether the collaboration software can be connected to units to be set or other components. Therefore, if the checking is made for a plurality of components, the number of procedures therefor is to be increased.

The present invention has been achieved in view of the above problems, and an object of the present invention is to provide a system development support tool that facilitates collaboration with collaboration software, has a less number of registration procedures of the collaboration software, and facilitates checking of connection to the collaboration software.

### Solution to Problem

To solve the above problems and achieve the object, a system architecture support tool that supports construction of a system including a programmable controller, a plurality of units being connected in the programmable controller, the system architecture support tool including: a display unit that displays a system-configuration setting screen including a system-configuration display area and a list display area, topology of the system being displayed in the system-configuration display area; a collaboration-software product-specification storage unit that stores therein a setting target of collaboration software and network information in association with each other for each collaboration software, the collaboration software being used for setting of the unit, the network information indicating a network used for connection with the setting target; a collaboration-software display unit that list-displays, in the list display area, the collaboration software stored in the collaboration-software product-specification storage unit as a component list; an automatic connection checking unit that determines whether the collaboration software selected from the component list and arranged in the system-configuration display area can be connected to the setting target based on the network information; and a collaboration-software arrangement unit that connects, when the automatic connection checking unit determines that the collaboration software is connectable to the setting target, an image representing the collaboration software arranged in the system-configuration display area to the system of which topology is displayed in the system-configuration display area based on the network information, and displays the image.

### Advantageous Effects of Invention

According to a system architecture support tool of the present invention, collaboration with collaboration software is facilitated, the number of registration procedures of the collaboration software is reduced, and the effort of checking connection to the collaboration software can be saved.

### BRIEF DESCRIPTION OF DRAWINGS

FIG. 1 is a diagram illustrating a hardware configuration of a computer having incorporated therein a system architecture support tool according to an embodiment.

FIG. 2 is a functional block diagram of a system architecture support tool formed on a computer and including a central processing unit and a storage device.

FIG. 3 is a functional block diagram of a system architecture support tool formed on a computation unit by executing a system-architecture support-tool program by the computation unit.

FIG. 4 is a diagram illustrating one example of an operation of the system architecture support tool.

FIG. 5 is a diagram illustrating a configuration of a collaboration-software product-specification storage unit.

FIG. 6 is a flowchart illustrating an operation of registering collaboration software as component data.

FIG. 7 is a flowchart illustrating an operation of when collaboration software registered as component data is displayed in a network-configuration display area.

### DESCRIPTION OF EMBODIMENTS

Exemplary embodiments of a system architecture support tool according to the present invention will be explained below in detail with reference to the accompanying drawings. The present invention is not limited to the embodiments.

### Embodiment

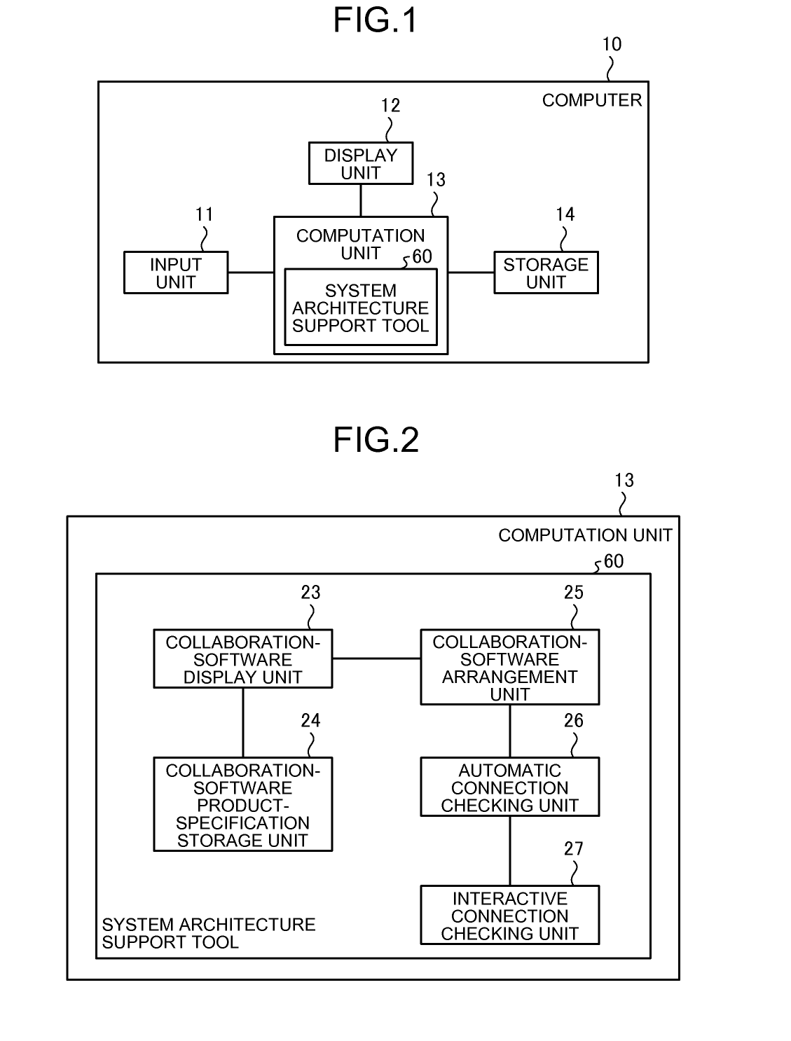

FIG. 1 is a diagram illustrating a hardware configuration of a computer having incorporated therein a system architecture support tool according to an embodiment. A computer 10 having incorporated therein the system architecture support tool includes an input unit 11, a display unit 12, a computation unit 13, and a storage unit 14. The input unit 11 is a device such as a keyboard or a pointing device. The display unit 12 is a display such as a CRT (Cathode Ray Tube) display, an LCD (Liquid Cristal Display), or an organic EL display. The computation unit 13 is a unit such as a CPU (Central Processing Unit) or an MPU (Micro Processing Unit). The storage unit 14 includes a nonvolatile storage area and a volatile storage area, and stores product specifications and the like in the nonvolatile storage area. The volatile storage area is appropriately used as a work memory (a work area) when the computation unit 13 is operated. The computation unit 13 executes a system-architecture support-tool program while having the volatile storage area of the storage unit 14 as a work area. Consequently, a system architecture support tool 60 is formed on the computation unit 13. The system architecture support tool 60 is used when a system including a programmable logic controller (PLC: Programmable Logic Controller), a programmable display device, and the like is constructed.

FIG. 2 is a functional block diagram of the system architecture support tool. In FIG. 2, the storage unit 14 serving as the work area is not illustrated. The system architecture support tool 60 includes: a collaboration-software display unit 23 that displays collaboration software on the display unit 12; a collaboration-software product-specification storage unit 24 that stores therein specifications of respective pieces of collaboration software; a collaboration-software arrangement unit 25 that arranges collaboration software on the display device 12; an automatic connection checking unit 26 that checks connection between collaboration software and units set by the collaboration software; and an interactive connection checking unit 27.

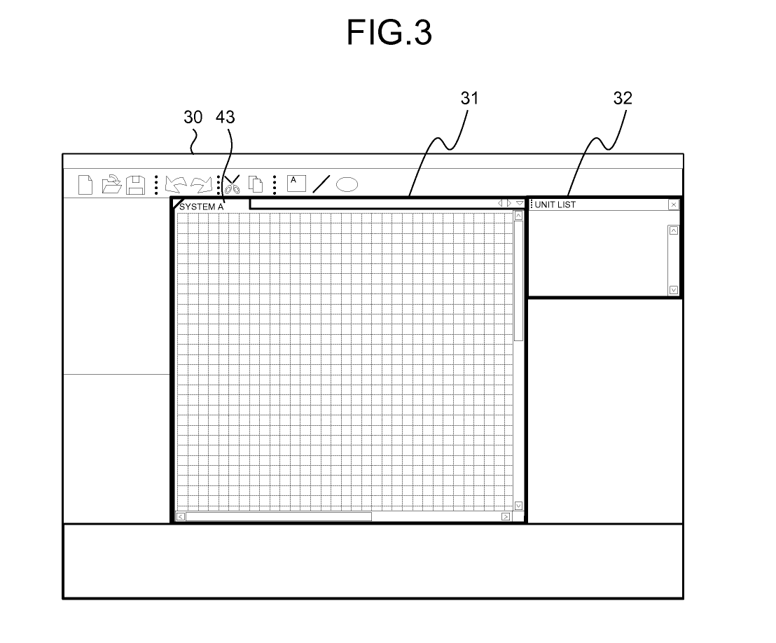

FIG. 3 is a diagram illustrating an example of a system-configuration setting screen that the system architecture support tool 60 causes the display unit 12 to display. A system-configuration setting screen 30 includes a system-configuration display area 31 and a list display area 32. In the system-configuration display area 31, editing operations such as creation of system configuration information and the like is performed. In the list display area 32, units and components required for editing a unit configuration and listed information of a network are displayed. In the system-configuration display area 31, topology of a system is displayed. The system-configuration display area 31 includes a tab 43 on which a system configuration name is displayed. A system configuration that is selected by selecting a tab can be displayed on the system-configuration setting screen 30.

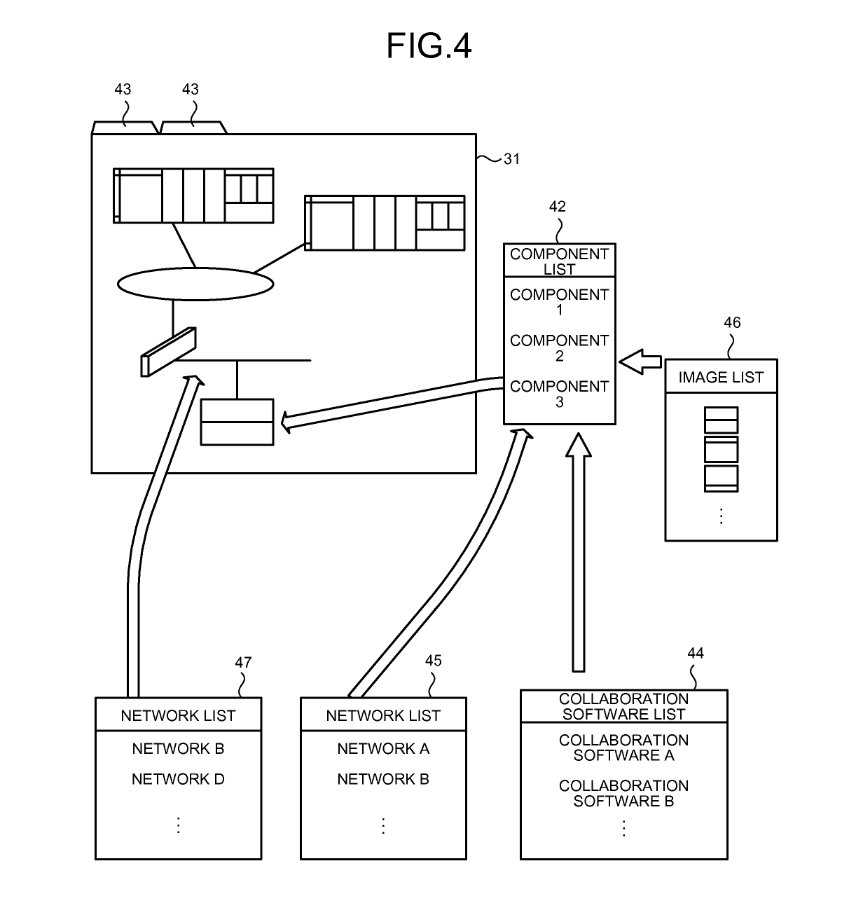

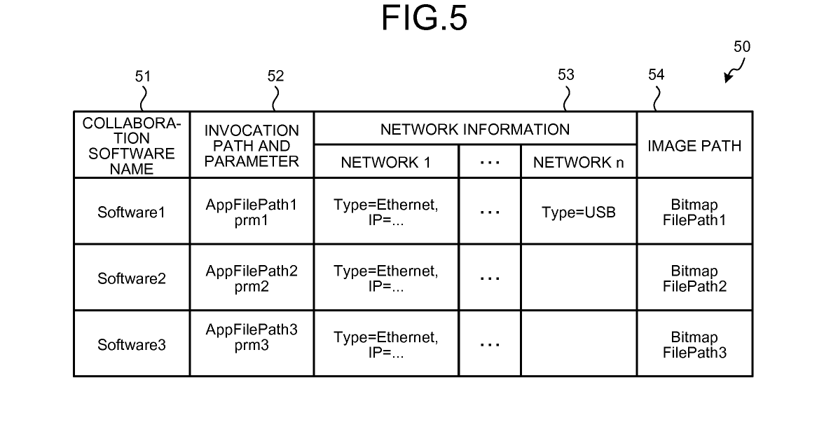

FIG. 4 is a diagram of an example of an operation of the system architecture support tool 60. A user of the system architecture support tool 60 operates the input unit 11, and specifies collaboration software and an invocation parameter (a command to a unit) by a collaboration software list 44 displayed in the list display area 32. Furthermore, the user operates the input unit 11 to specify an image (such as a bitmap image) of the collaboration software from an image list 46, which is displayed on the display unit 12 and in a different area or a different dialog from the system-configuration display area 31. The user selects network information of the collaboration software from a network list 45 displayed in the list display area 32. Here, a plurality of pieces of the network information can also be selected. The collaboration software is registered in a component list 42 as component data with the above procedures. Further, the user operates the input unit 11 and selects the collaboration software registered as the component data from the component list 42 displayed in the list display area 32 to arrange the selected collaboration software in the system-configuration display area 31. For example, the user operates a mouse as the input unit 11 to drag desired collaboration software on the component list 42. Then, the user operates the mouse to drop the collaboration software in the system-configuration display area 31. Accordingly, the collaboration software is arranged in the system-configuration display area 31. With this process, the collaboration software arranged in the system-configuration display area 31 is displayed in the system-configuration display area 31 in a state in which the collaboration software is connected to a network having been selected at the time of registering the collaboration software as the component data. As described later, in the selected network, when the collaboration software arranged in the system-configuration display area 31 cannot be connected to a setting target, a network list 47 is displayed in the list display area 32. Thereafter, the user operates the input unit 11 to connect the collaboration software and the setting target with each other through a network selected from the network list 47, and the collaboration software is displayed in the system-configuration display area 31.

FIG. 5 is a diagram illustrating a structure of data stored in the collaboration-software product-specification storage unit 24. Data is stored in the collaboration-software product-specification storage unit 24 as a product-specification storage table 50. The product-specification storage table 50 stores therein, for each piece of collaboration software, a collaboration software name 51, an invocation path and parameter 52 of collaboration software, network information 53 that connects collaboration software and a device to be set, and an image path 54 that displays collaboration software in the system-configuration display area 31.

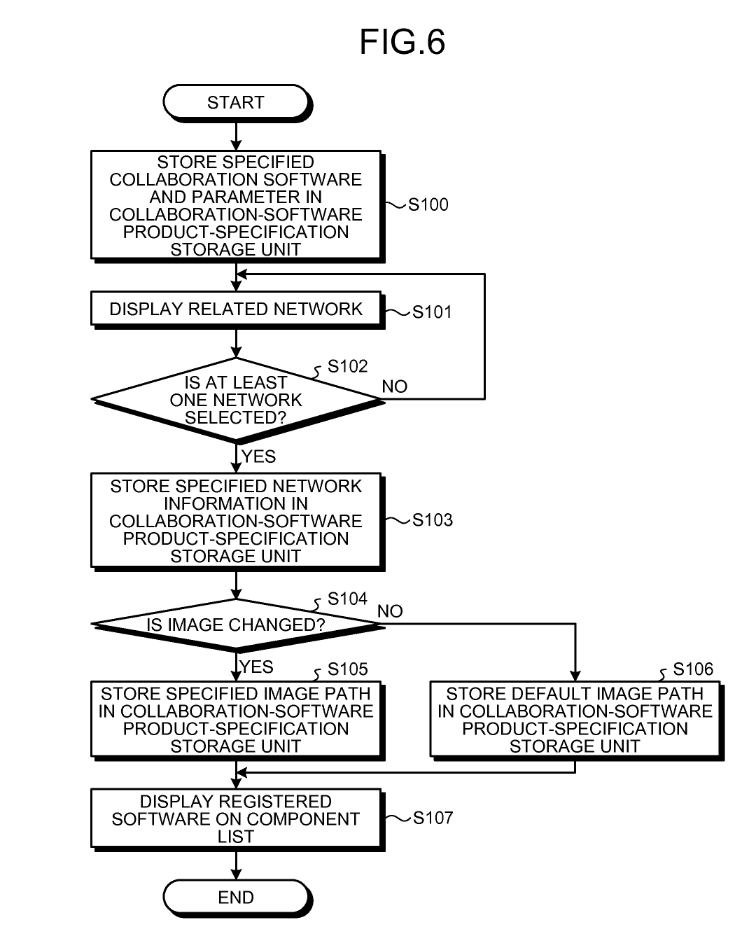

FIG. 6 is a flowchart illustrating an operation of registering collaboration software as component data. A user operates the input unit 11 to select and specify collaboration software from the collaboration software list 44 displayed in the list display area 32. If necessary, the user also specifies an invocation parameter of the collaboration software. For example, when there are a plurality of setting target units in the collaboration software, an invocation parameter is specified in order to identify the setting target units. With this process, it becomes possible to register the collaboration software including a plurality of setting target units as component data. The collaboration-software product-specification storage unit 24 stores therein the collaboration software name 51 and the invocation path and parameter 52 of the specified collaboration software (Step S100). Next, the collaboration-software display unit 23 displays a related network as the network list 45 in the list display area 32 (Step S101). The user operates the input unit 11 to select at least one network from the network list 45 (Step S102). When at least one network is selected by the user's operation of the input unit 11 (YES at Step S102), the user operates the input unit 11 to specify the name of the collaboration software. When no network is selected by the user's operation of the input unit 11 (NO at Step S102), the process returns to Step 5101.

The collaboration-software product-specification storage unit 24 stores therein information of the specified network (the network information 53) (Step S103). When an image of the collaboration network is changed (YES at Step 104), as the user operates the input unit 11 to input the image path 54, an image at the time of displaying the collaboration software is specified. The collaboration-software product-specification storage unit 24 stores therein the image path 54 of the specified image (Step S105). Meanwhile, when the image is not changed (NO at Step S104), the collaboration-software product-specification storage unit 24 stores therein a predetermined information (Step S106). By causing images of collaboration software to be able to be changed, even when a plurality of pieces of collaboration software are displayed in the system-configuration display area 31, these pieces can be easily distinguished from one another. Because the software name 51, the invocation path and parameter 52, the network information 53, and the image path 54 are stored in the collaboration-software product-specification storage unit 24, the collaboration software is registered as component data. The collaboration-software display unit 23 displays the collaboration software that is registered as the component data in the collaboration-software product-specification storage unit 24 on the component list 42 (Step S107).

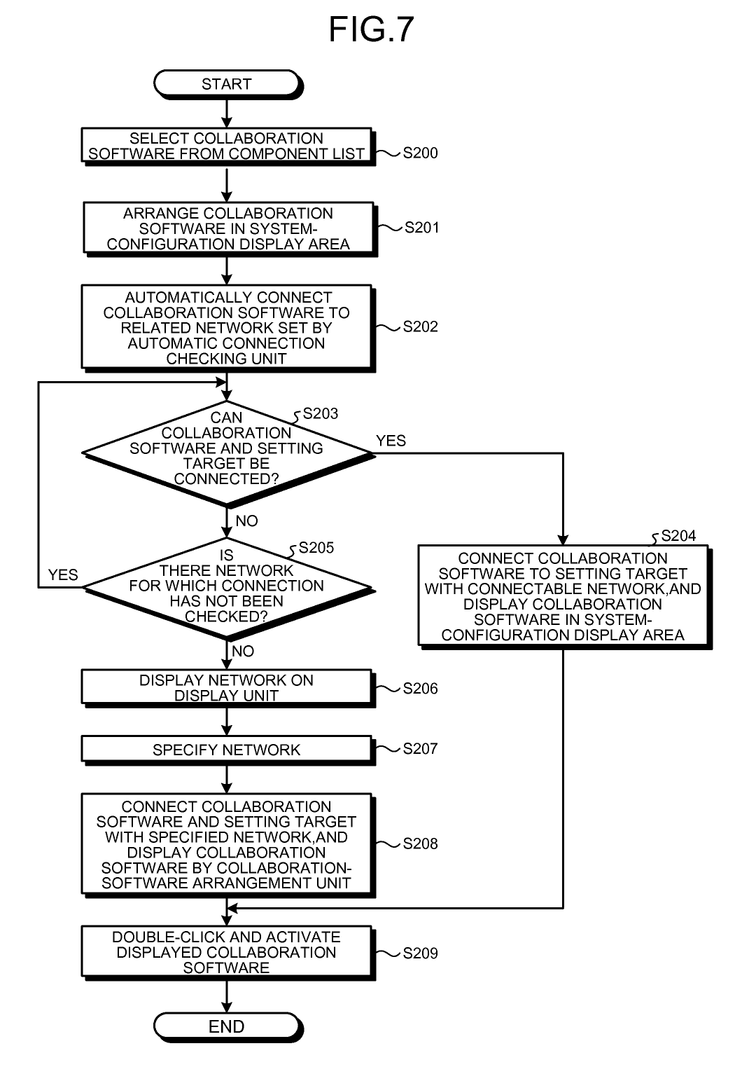

FIG. 7 is a flowchart illustrating an operation of when collaboration software registered as the component data is displayed on the network-configuration display area. A user operates the input unit 11 to select collaboration software from the component list 42 displayed in the list display area 32 (Step S200), and arranges the collaboration software in the system-configuration display area 31 (Step S201). For example, the user operates a mouse as the input unit 11 to drop collaboration software having been dragged on the component list 42 in the system-configuration display area 31. The automatic connection checking unit 26 automatically connects the collaboration software arranged in the system-configuration display area 31 to a network (Step S202). The automatic connection checking unit 26 automatically checks the connection between the collaboration software arranged in the system-configuration display area 31 and a setting target thereof based on the network information 53 (Step S203). Publicly known methods can be applied to the automatic connection checking.

When the automatic connection checking unit 26 determines that the connection can be made (YES at Step S203), the collaboration-software arrangement unit 25 connects the collaboration software arranged in the system-configuration display area 31 to a setting target via a connectable network, and displays the collaboration software in the system-configuration display area 31 (Step S204). When the automatic connection checking unit 26 determines that the connection cannot be made (NO at Step S203), it is checked whether, among the networks stored as the network information 53 of the collaboration software arranged in the system-configuration display area 31, there is any network for which connection to the setting target has not been checked (Step S205). When, among the networks stored as the network information 53, there is a network for which connection to the setting target has not been checked (YES at Step S205), the process returns to Step S203 and the automatic connection checking unit 26 checks the connection between the collaboration software arranged in the system-configuration display area 31 and the setting target. When, among the networks stored as the network information 53, there is no any network for which connection to the setting target has not been checked (NO at Step S205), the interactive connection checking unit 27 displays the network list 47 in the list display area 32 (Step S206). On the network list 47 that is displayed by the interactive connection checking unit 27, networks excluding a network selected at the time of registration at Step S102 are list-displayed. This is because, as for the network selected at the time of registration at Step S102, it is determined that the network cannot be connected with the process at Step S203.

The user operates the input unit 11 to specify one of the networks included in the network list 47 (Step S207). The collaboration-software arrangement unit 25 connects the collaboration software and a setting target via the specified network, and displays the collaboration software in the system-configuration display area 31 (Step S208). As the user operates the input unit 11 to select an icon of the collaboration software displayed in the system-configuration display area 31, the collaboration software can be activated (Step S209).

As described above, in the system architecture support tool according to the present embodiment, if collaboration software can be connected to a network selected by a user, it is not necessary to perform setting in an interactive manner.

### INDUSTRIAL APPLICABILITY

As described above, the system architecture support tool according to the present invention is useful in an aspect that the workload at the time of constructing a complicated system or a large-scale system can be reduced.

### REFERENCE SIGNS LIST

10 Computer
11 Input unit
12 Display unit
13 Computation unit
14 Storage unit
23 Collaboration-software display unit
24 Collaboration-software product-specification storage unit
25 Collaboration-software arrangement unit
26 Automatic connection checking unit
27 Interactive connection checking unit
30 System-configuration setting screen
31 System-configuration display area
32 List display area
42 Component list
43 Tab
44 Collaboration software list
45, 47 Network list
46 Image list
50 Product-specification storage table
51 Collaboration software name
52 Invocation path and parameter
53 Network information
54 Image path
60 System architecture support tool

1. A system architecture support tool that supports construction of a system including a programmable controller, in which a plurality of units are connected the system architecture support tool comprising:
a display unit that displays a system-configuration setting screen including a system-configuration display area and a list display area, topology of the system being displayed in the system-configuration display area;
a collaboration-software product-specification storage unit that stores therein a setting target of collaboration software and network information in association with each other for each collaboration software, the collaboration software being used for setting of the unit, the network information indicating a network used for connection with the setting target;
a collaboration-software display unit that list-displays, in the list display area, the collaboration software stored in the collaboration-software product-specification storage unit as a component list;
an automatic connection checking unit that determines whether the collaboration software selected from the component list and arranged in the system-configuration display area can be connected to the setting target based on the network information; and
a collaboration-software arrangement unit that connects, when the automatic connection checking unit determines that the collaboration software is connectable to the setting target, an image representing the collaboration software arranged in the system-configuration display area to the system, topology of which is displayed in the system-configuration display area based on the network information, and displays the image.

2. The system architecture support tool according to claim 1, wherein the collaboration-software product-specification storage unit further associates a parameter for specifying the setting target of the collaboration software, and stores the parameter therein.

3. The system architecture support tool according to claim 1, wherein the image representing the collaboration software arranged in the system-configuration display area is made changeable.

4. The system architecture support tool according to claim 1, further comprising an interactive connection checking unit that selects, when the automatic connection checking unit determines that the collaboration software selected from the component list and arranged in the system-configuration display area cannot be connected to the setting target, a network used for connection between the collaboration software selected from the component list and arranged in the system-configuration display area and the setting target by an interactive process.
